(19) United States
(12) Patent Application Publication
(10) Pub. No.: US 2014/0124429 A1
(43) Pub. Date: May 8, 2014

(54) PITCHERS, PITCHER AND FILTER BASE COMBINATIONS, DISPENSERS, DISPENSER AND FILTER BASE COMBINATIONS, AND FILTER BASES

(71) Applicants: David Rinaldis, Redwood City, CA (US); Henry Sim, Mountain View, CA (US); Arthur Kwun, Newark, CA (US); Martin Leugers, San Francisco, CA (US); Josh Druker, Redwood City, CA (US); Stephen Senatore, South San Francisco, CA (US); Kevin Simmons, San Francisco, CA (US); Mark Mcnally, San Francisco, CA (US); Graham Faulknor, San Mateo, CA (US)

(72) Inventors: David Rinaldis, Redwood City, CA (US); Henry Sim, Mountain View, CA (US); Arthur Kwun, Newark, CA (US); Martin Leugers, San Francisco, CA (US); Josh Druker, Redwood City, CA (US); Stephen Senatore, South San Francisco, CA (US); Kevin Simmons, San Francisco, CA (US); Mark Mcnally, San Francisco, CA (US); Graham Faulknor, San Mateo, CA (US)

(21) Appl. No.: 13/987,291

(22) Filed: May 13, 2012

(51) Int. Cl. B01D 27/02

(52) U.S. Cl. CPC C02F 1/003
USPC 210/282

(57) ABSTRACT

Filtration systems, such as those having a pitcher that includes a lid, a base configured to be coupled to the lid such that the base and the lid cooperate to define a container configured to hold fluid, and a divider separating the container into two compartments that are alongside but not over/under each other and a filter base configured to be coupled to the pitcher.

### BACKGROUND

The present invention relates generally to designs for: pitchers (such as those configured to hold drinking water) and portions of pitchers, pitchers docked in filter bases (and portions of same), dispensers (such as those configured to hold drinking water) and portions of dispensers, dispensers docked in filter bases (and portions of same), and filter bases and portions of filter bases.

### SUMMARY

This disclosure includes designs for pitchers and portions of pitchers. Some of the present pitcher designs include portions that are clear, translucent, transparent, and/or opaque, such as a container portion configured to hold fluid (such as drinking water) and that may include two compartments oriented alongside (but not over/under) each other and separated by a divider. Some of the present pitcher designs do not include the bottom of the pitcher. Some of the present designs of pitcher portions include the handle (as well as any portion of the handle), the container portion (as well as any part of the container portion), the spout portion (as well as any part of the spout portion), and the lid of the container (as well as any portion of the lid, such as the top of the lid). Some of the present designs of pitcher portions do not include the bottom of any included portion. Some of the present pitcher and base designs include a portion of the base and/or the pitcher (such as a portion of the pitcher and/or the base that is visible when the pitcher and base are docked together, and including less than all of such a visible portion), and some do not include the bottom of any base, pitcher, or included portion of either.

This disclosure includes designs for dispensers and portions of dispensers. Some of the present dispenser designs include portions that are clear, translucent, transparent, and/or opaque, such as a container portion configured to hold fluid (such as drinking water). Some of the present dispenser designs do not include the bottom of the dispenser. Some of the present designs of dispenser portions include the container portion (as well as any part of the container portion), the dispenser portion lid (as well as any portion of the lid, such as the top of the lid), and the spout portion (as well as any part of the spout portion). Some of the present designs of dispenser portions do not include the bottom of any included portion. Some of the present dispenser and base designs include a portion of the base and/or the dispenser (such as a portion of the dispenser and/or the base that is visible when the dispenser and base are docked together, and including less than all of such visible portion), and some do not include the bottom of any base, dispenser, or included portion of either.

This disclosure includes designs for filter bases and portions of filter bases. Some of the present base designs do not include the bottom of the base. Some of the present designs of base portions include the front (including any part of the front) of the base, which has a low profile and on which a pitcher or dispenser may be placed, the rear of the base (including any part of the rear), and the top of the base (including any part of the top). Some of the present designs of base portions do not include the bottom of any included portion.

Any of the present designs may be claimed in a way that does not include a portion or portions of an interior that would otherwise be visible, such as by showing the border of that interior in dashed lines.

Any of the present designs may be claimed in a way that does not include all the features of a given one of the present pitcher, dispenser, base, dispenser and base, and pitcher and base designs, such as by showing a particular portion of a pitcher in dashed lines.

The designs presented in this disclosure may be claimed as ornamental designs for the pitchers, dispensers, bases, pitchers and bases, and dispensers and bases as shown and described in this disclosure.

### DRAWINGS DESCRIPTION

FIGS. 1-2 depict perspective views of an embodiment of the present pitchers.

FIGS. 3-4 depict perspective views of an embodiment of the present pitchers coupled to an embodiment of the present filter bases.

FIGS. 5-6 depict perspective views of an embodiment of the present pitchers.

FIGS. 7A-7B depict perspective views of embodiments of the present pitchers coupled to embodiments of the present filter bases.

FIGS. 8-9 depict a perspective view of an embodiment of the present pitchers coupled to an embodiment of the present filter bases.

FIGS. 10-12 depict a perspective view of at least a portion of an embodiment of the present pitchers.

FIGS. 13-14 depict perspective views of at least a portion of an embodiment of the present pitchers coupled to an embodiment of the present filter bases.

FIGS. 15-17 depict perspective views of at least a portion of an embodiment of the present filter bases.

FIG. 18 depicts a perspective view of an embodiment of the present pitchers.

FIG. 19 depicts a side view of an embodiment of the present pitchers.

FIG. 20 depicts a front view of an embodiment of the present pitchers.

FIG. 21 depicts a back view of an embodiment of the present pitchers.

FIG. 22 depicts a top view of an embodiment of the present pitchers.

FIG. 23 depicts a bottom view of an embodiment of the present pitchers.

FIGS. 24-25 depicts a perspective view of an embodiment of the present pitchers coupled to an embodiment of the present filter bases.

FIG. 26 depicts a side view of an embodiment of the present pitchers coupled to an embodiment of the present filter bases.

FIG. 27 depicts a front view of an embodiment of the present pitchers coupled to an embodiment of the present filter bases.

FIG. 28 depicts a back view of an embodiment of the present pitchers coupled to an embodiment of the present filter bases.

FIG. 29 depicts a side view of an embodiment of the present pitchers coupled to an embodiment of the present filter bases.

FIG. 30 depicts a top view of an embodiment of the present pitchers coupled to an embodiment of the present filter bases.

FIG. 31 depicts a bottom view of an embodiment of the present pitchers coupled to an embodiment of the present filter bases.

FIG. 32 depicts a perspective view of an embodiment of the present pitchers.

FIGS. 33-34 depict a side views of an embodiment of the present pitchers.

FIG. 35 depicts a back view of an embodiment of the present pitchers.

FIG. 36 depicts a front view of an embodiment of the present pitchers.

FIG. 37 depicts a top view of an embodiment of the present pitchers.

FIG. 38 depicts a bottom view of an embodiment of the present pitchers.

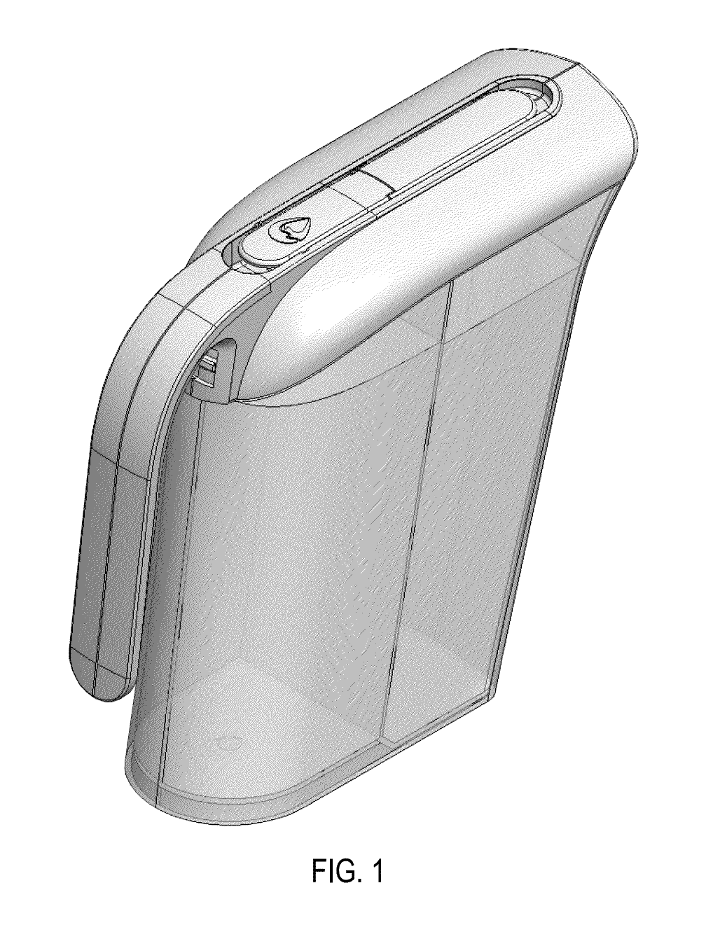

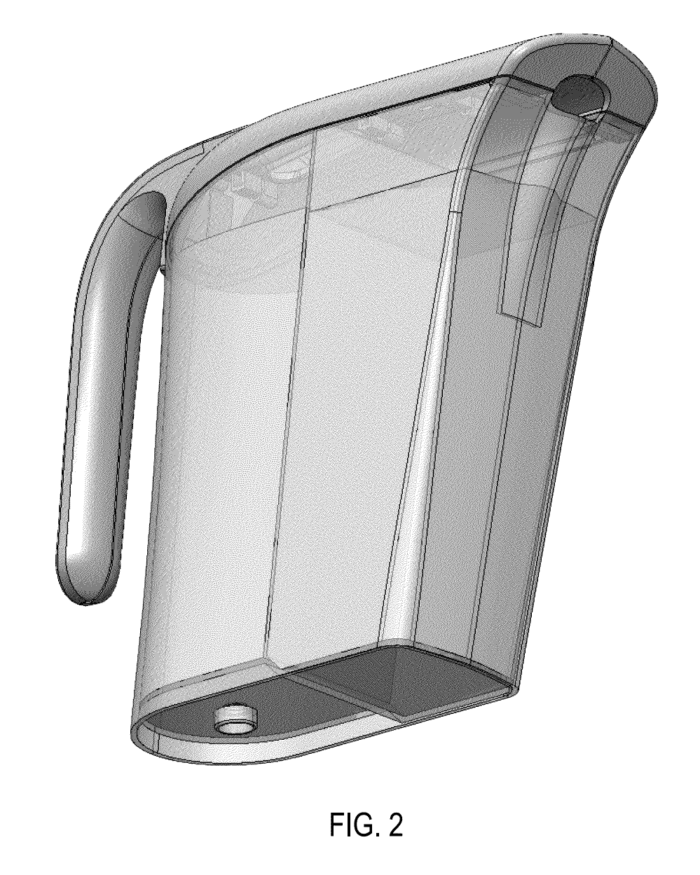

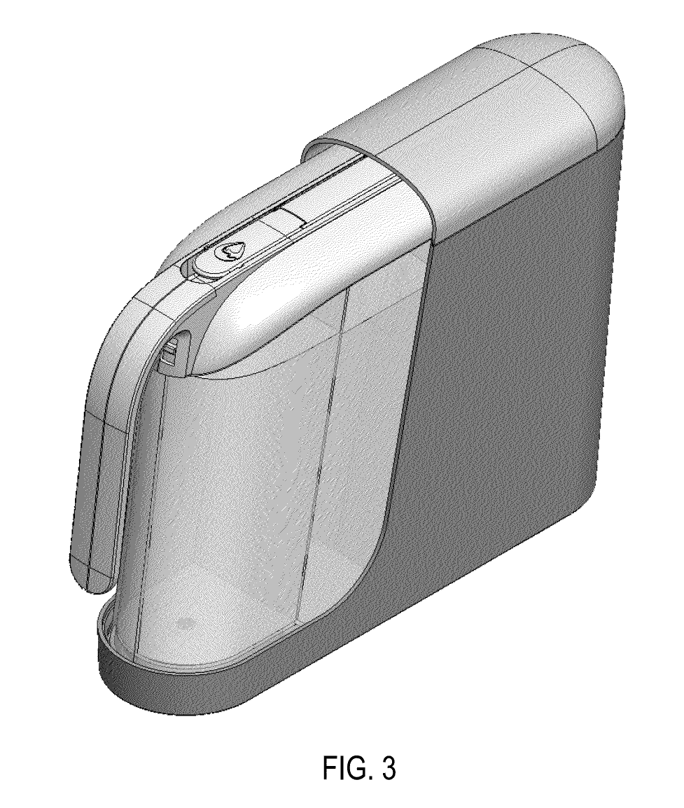

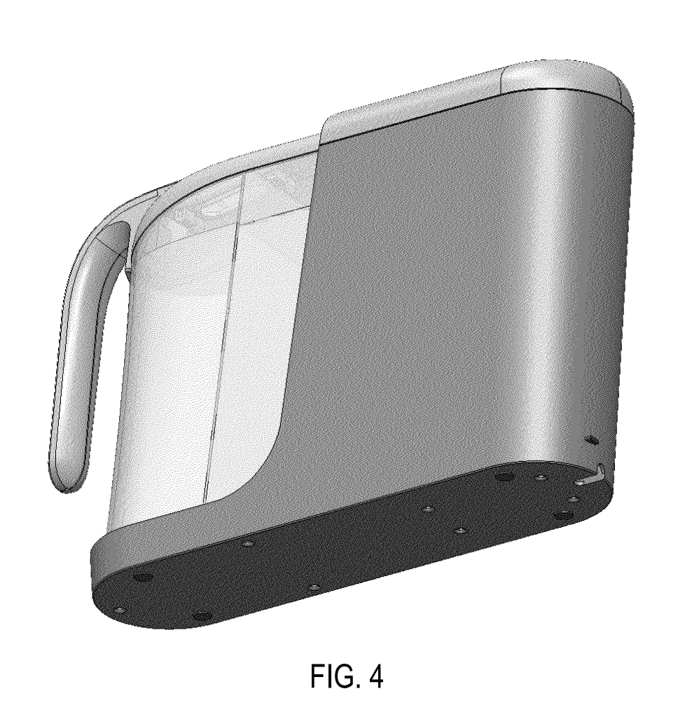

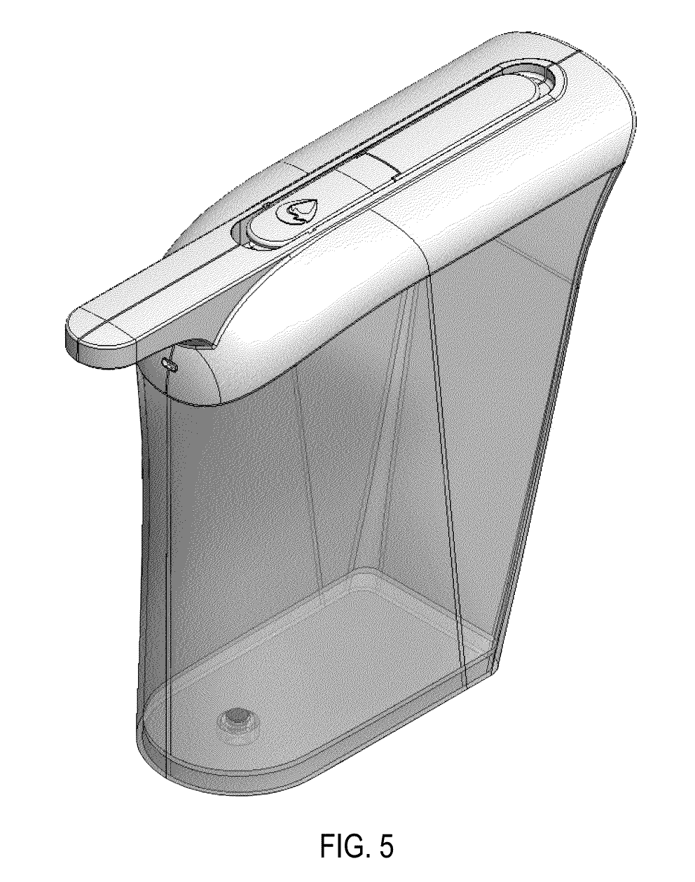

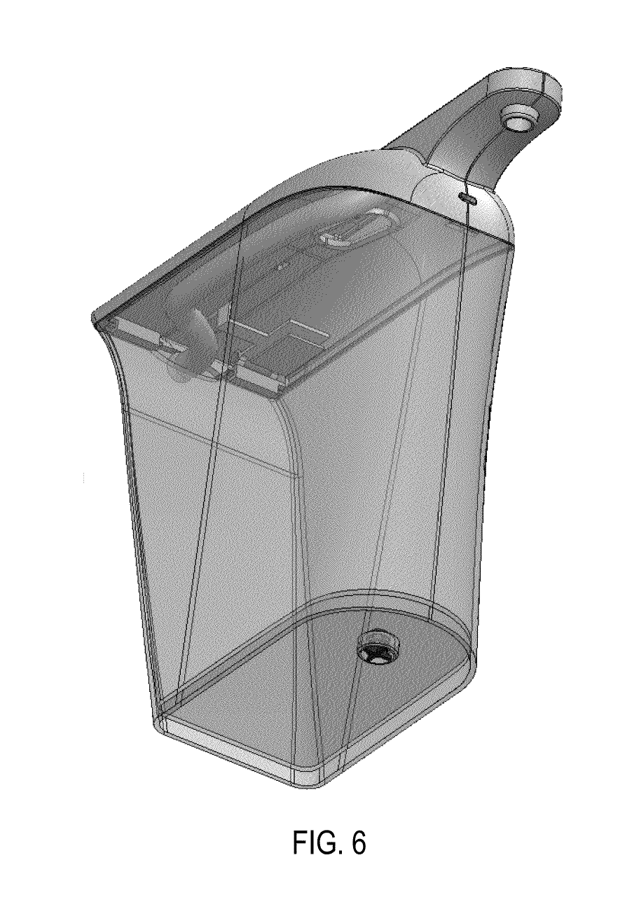

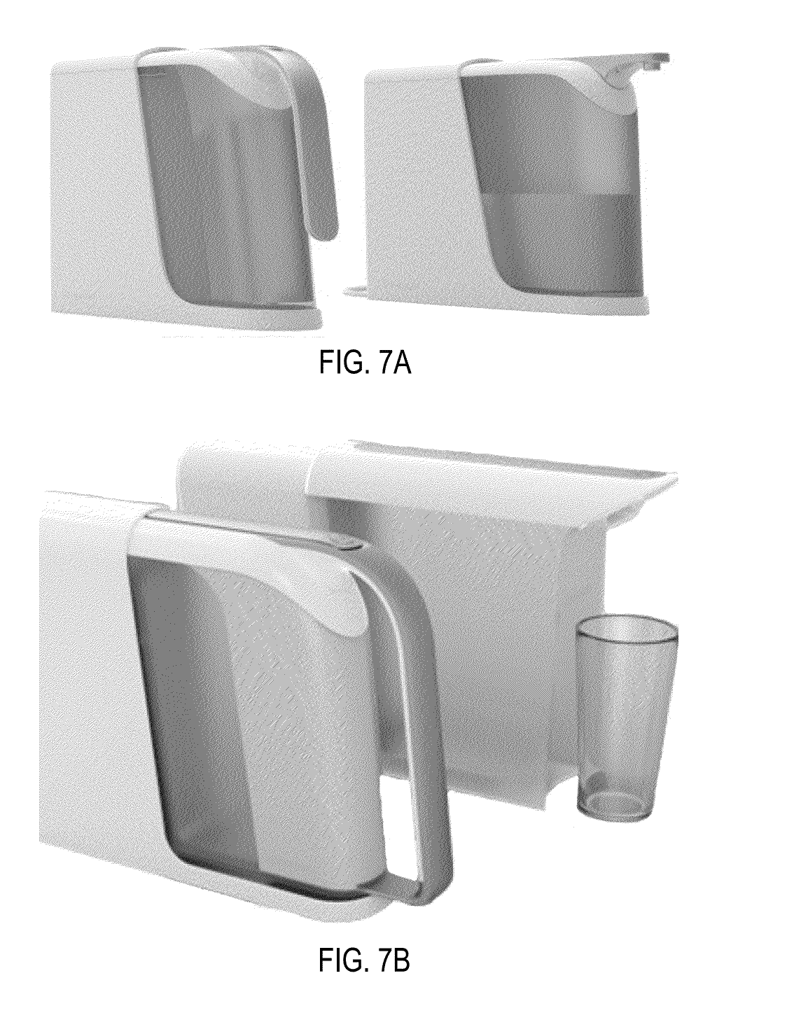

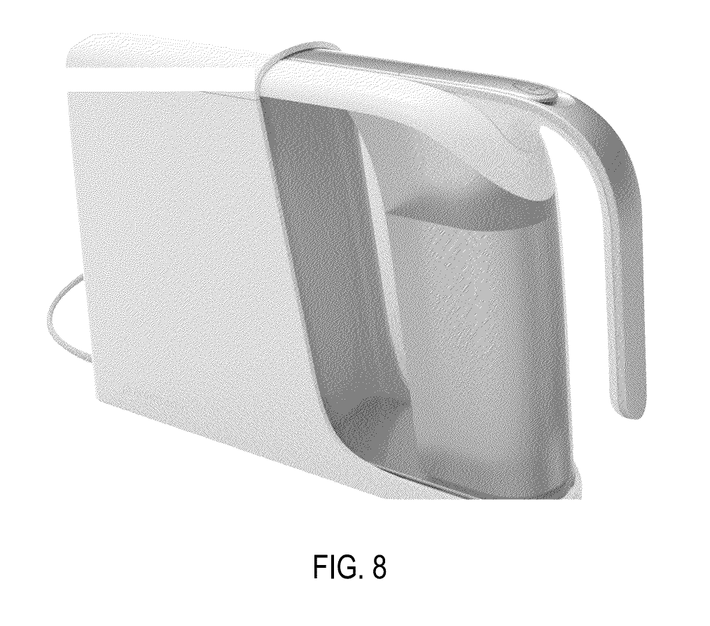

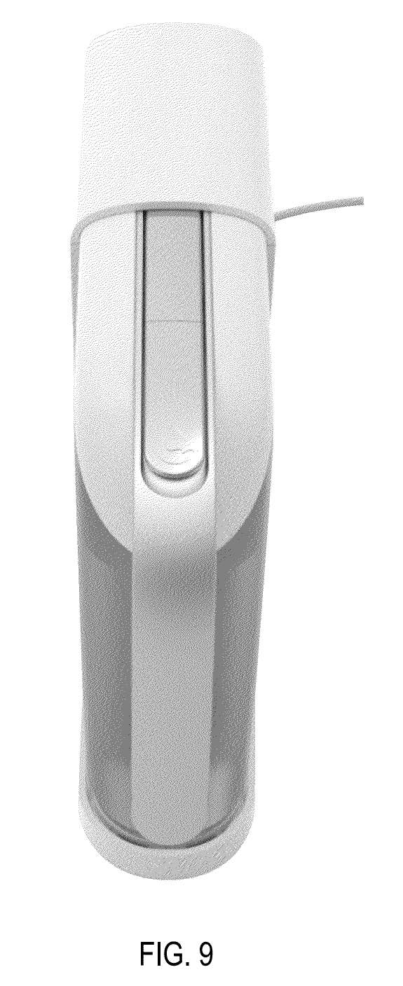

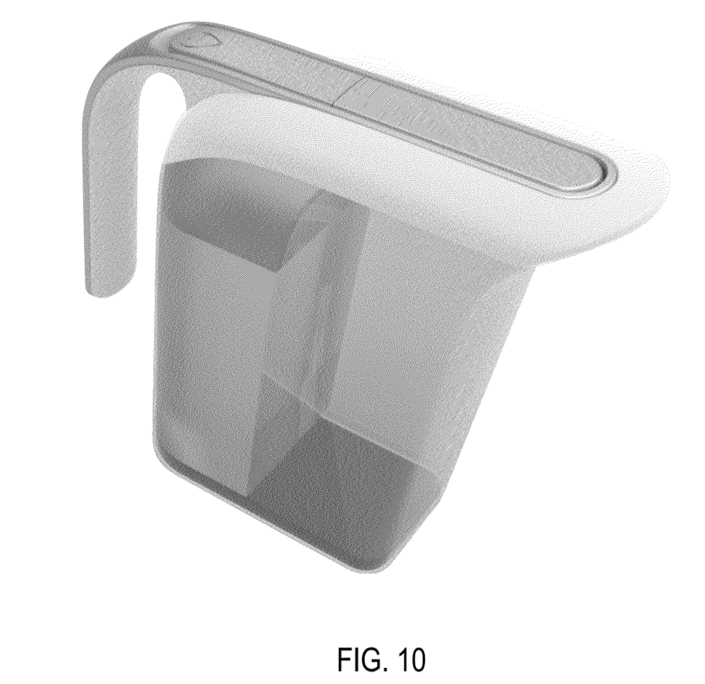

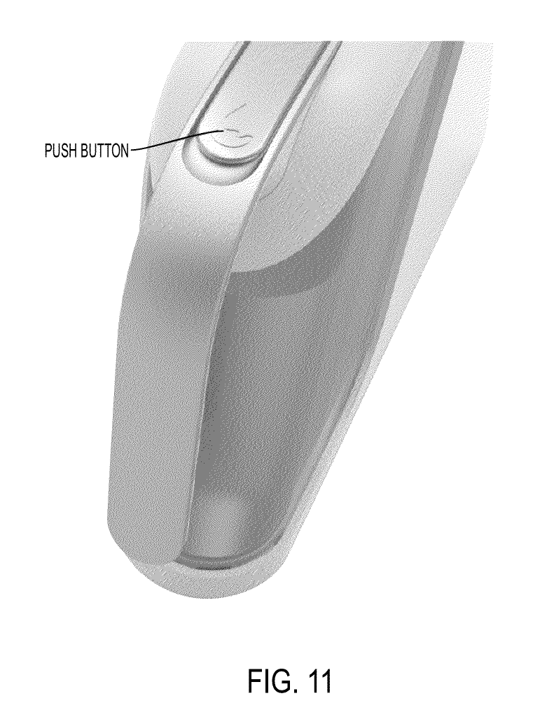

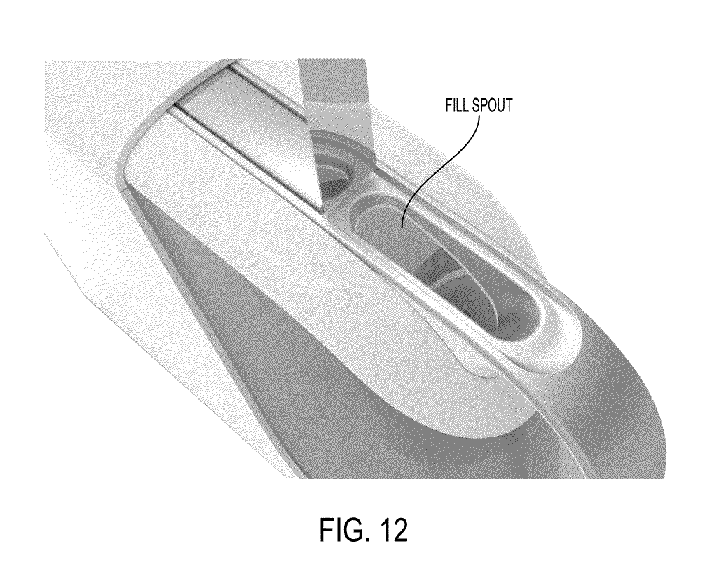

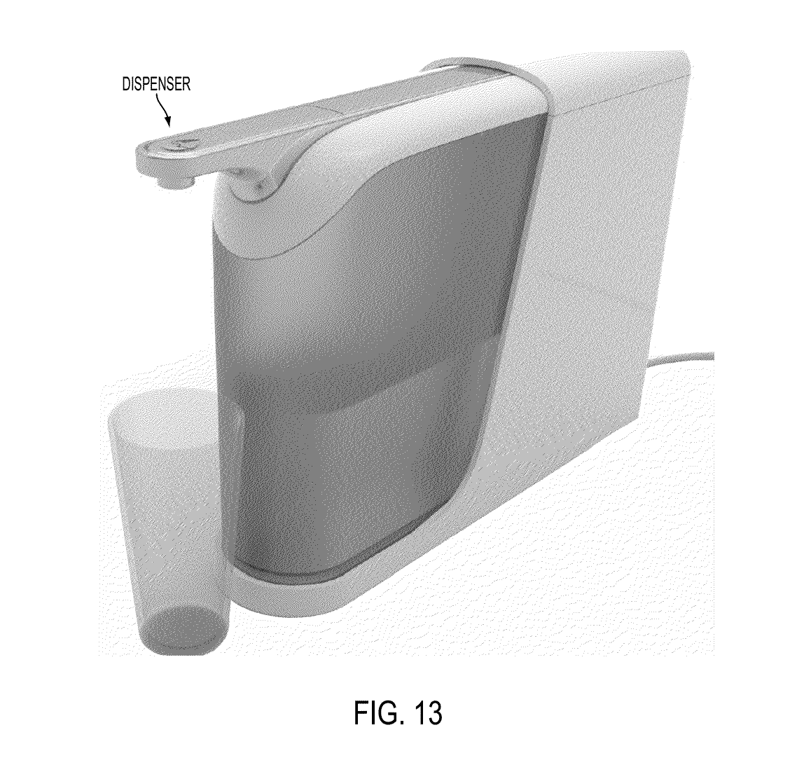

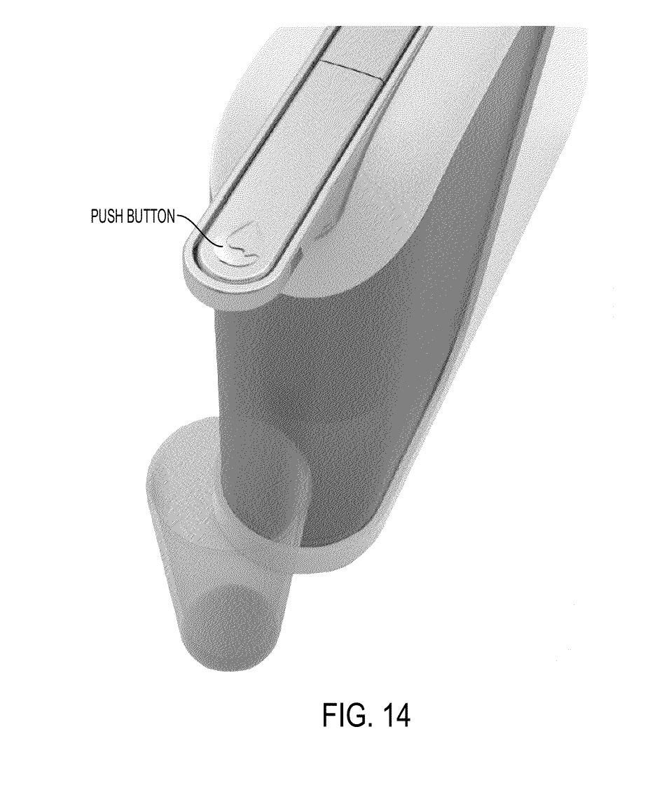

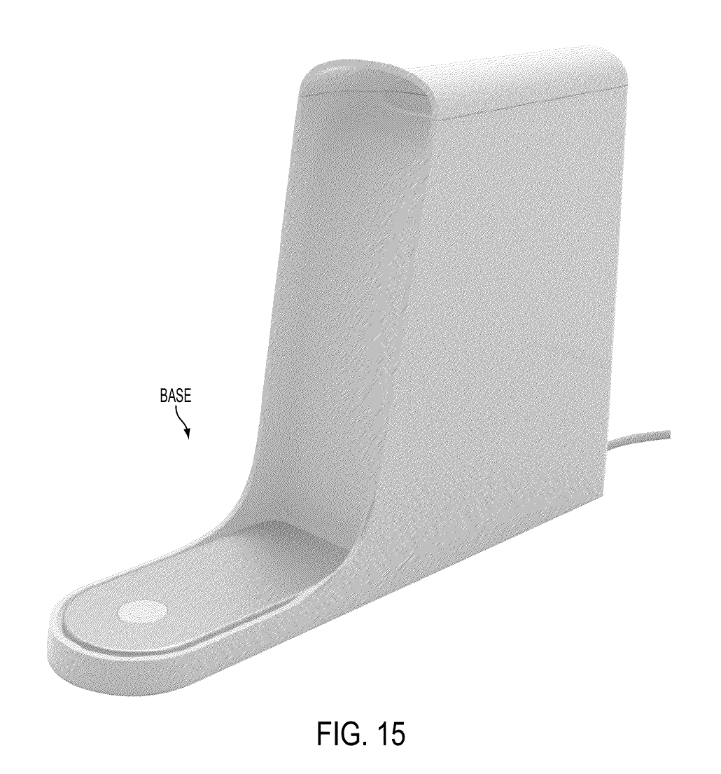

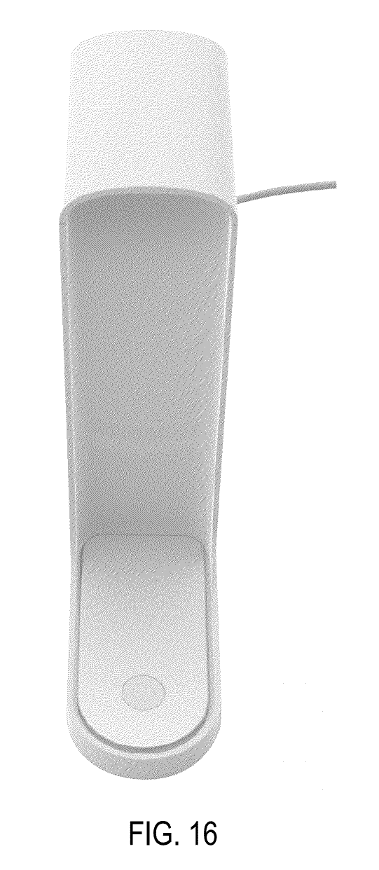

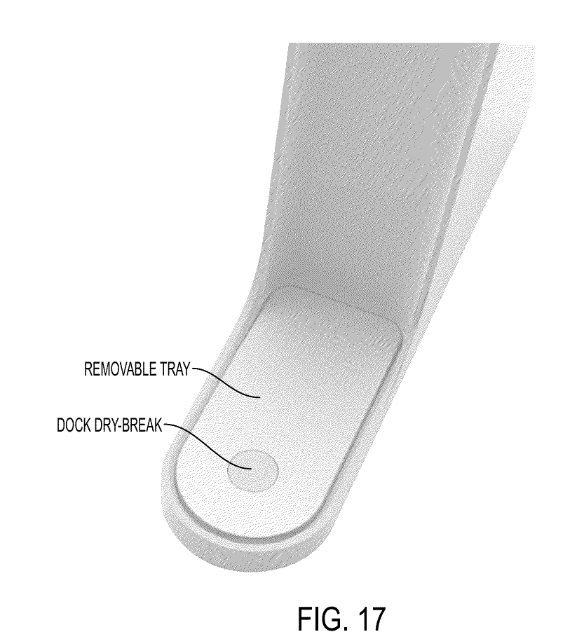

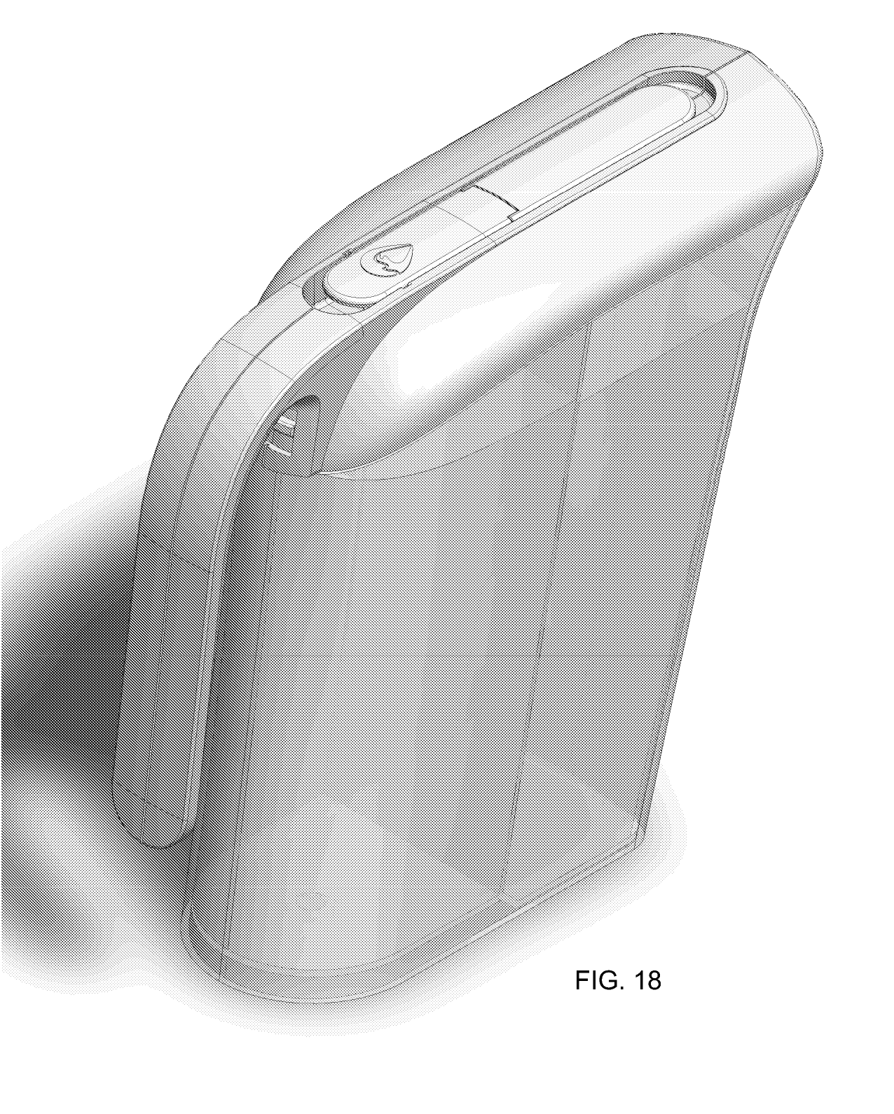

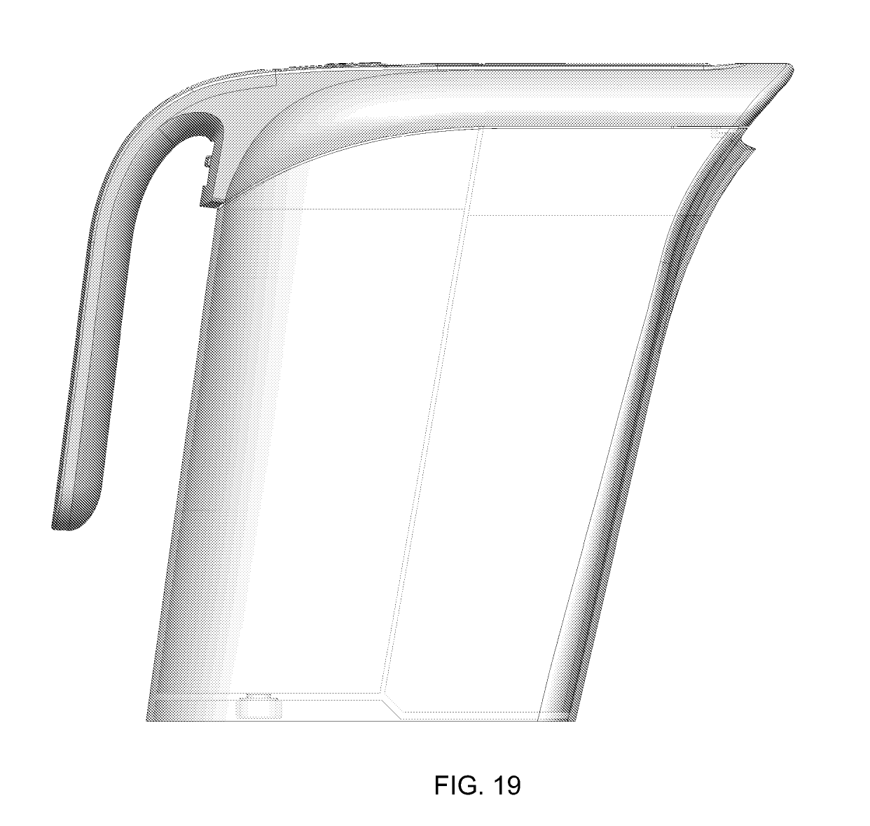

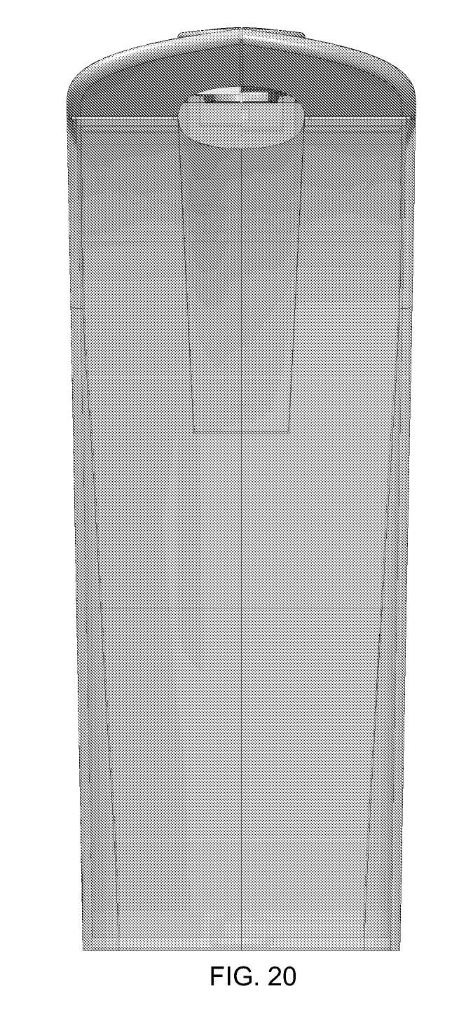

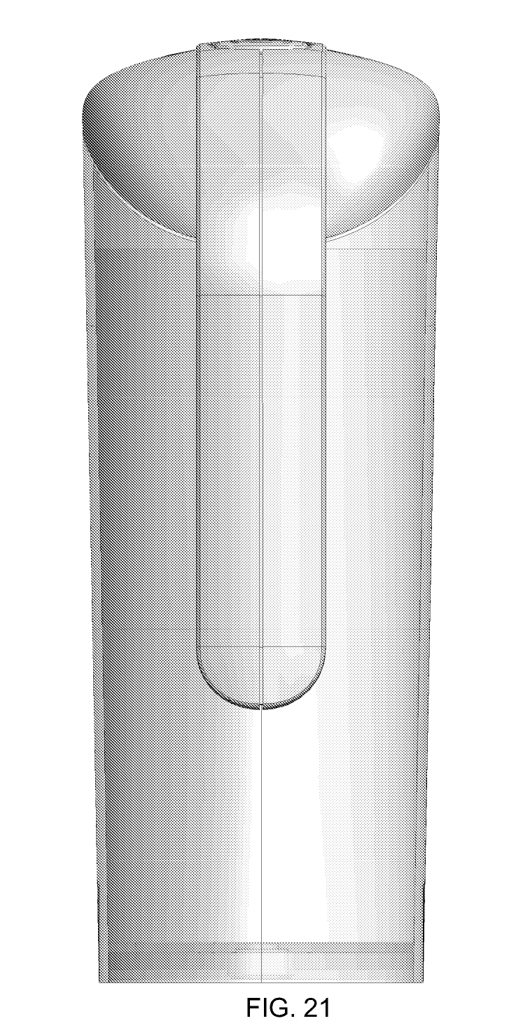

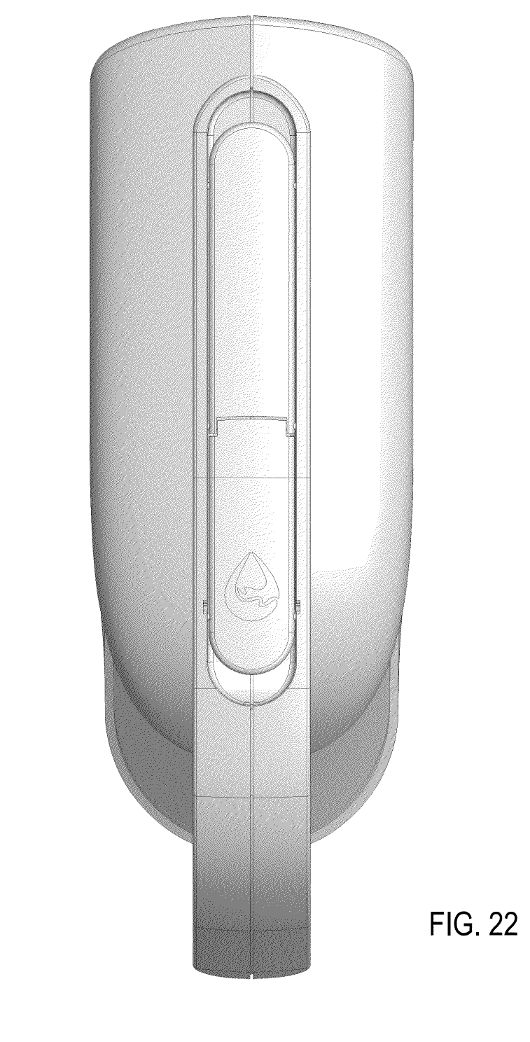

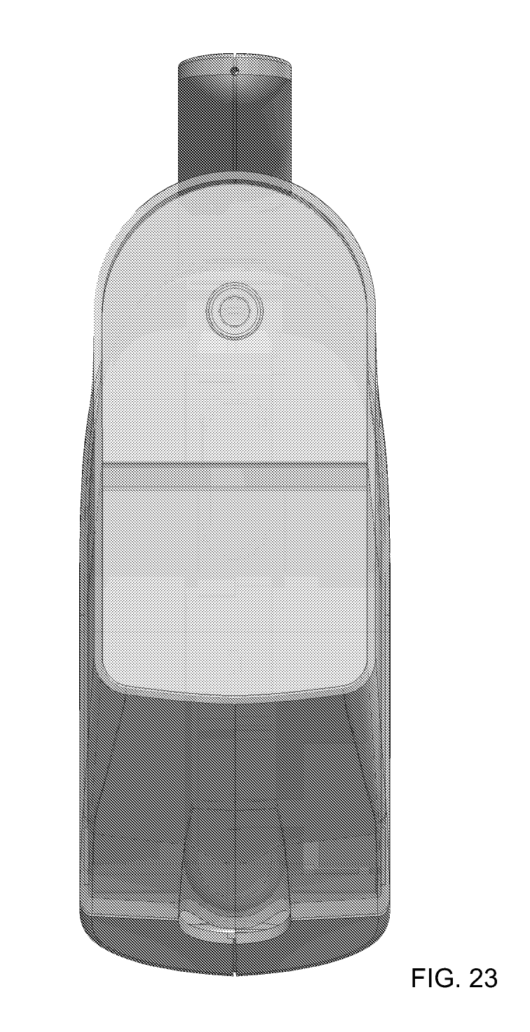

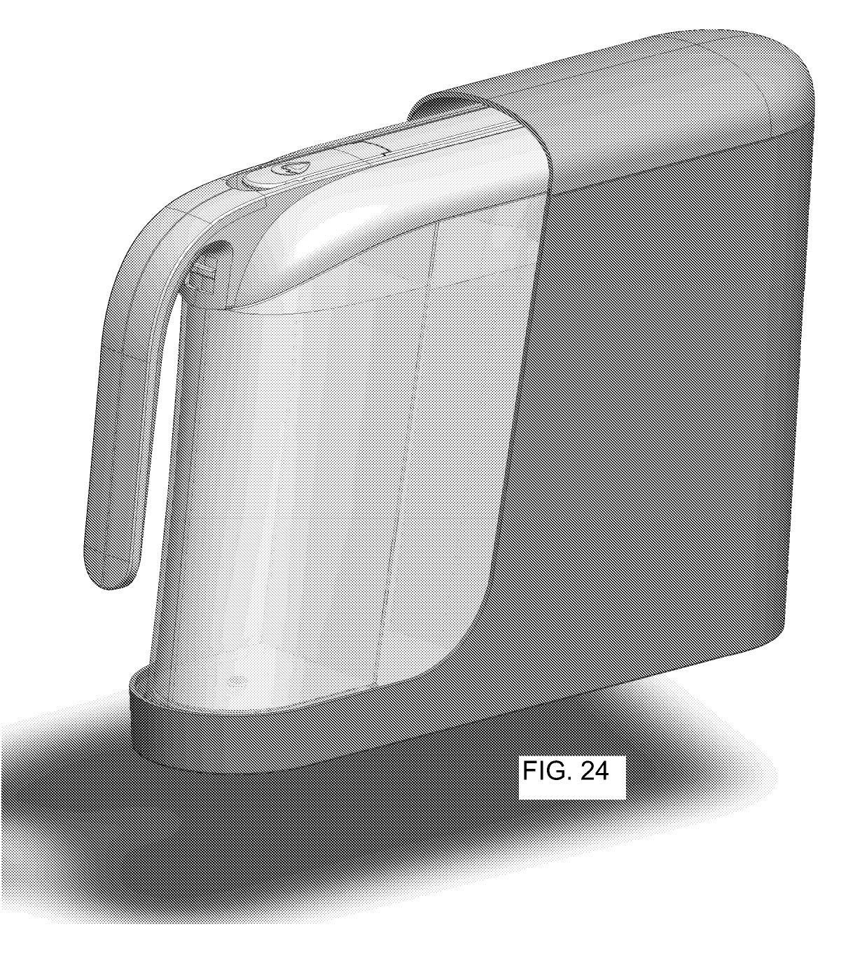

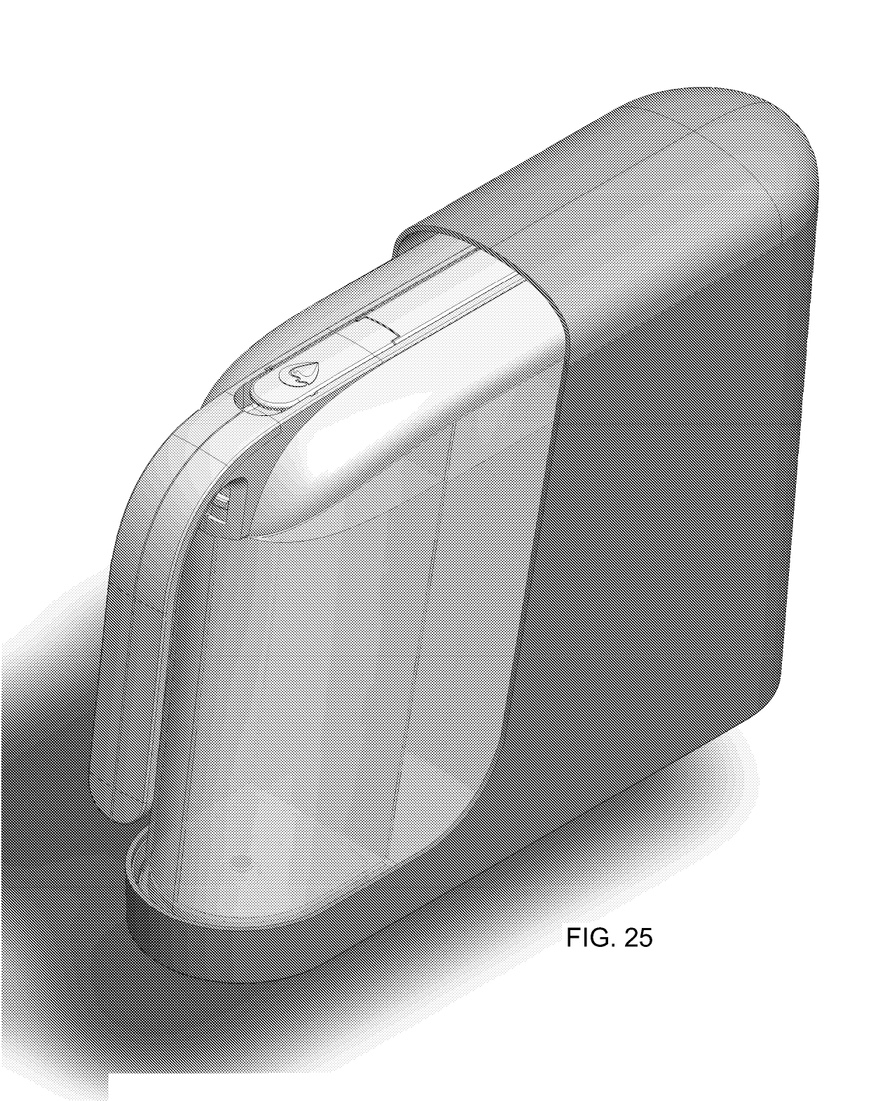

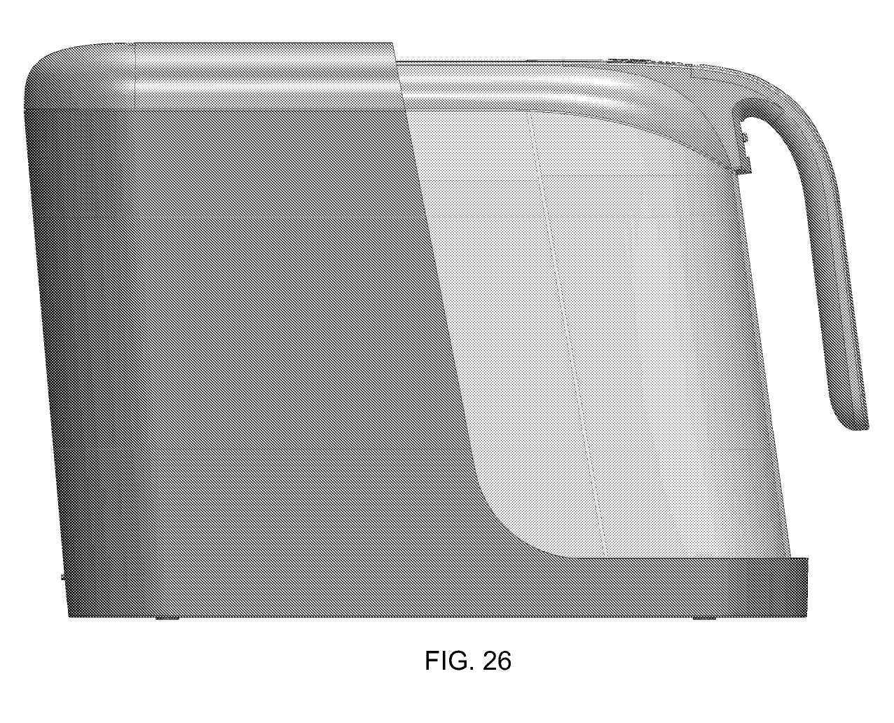

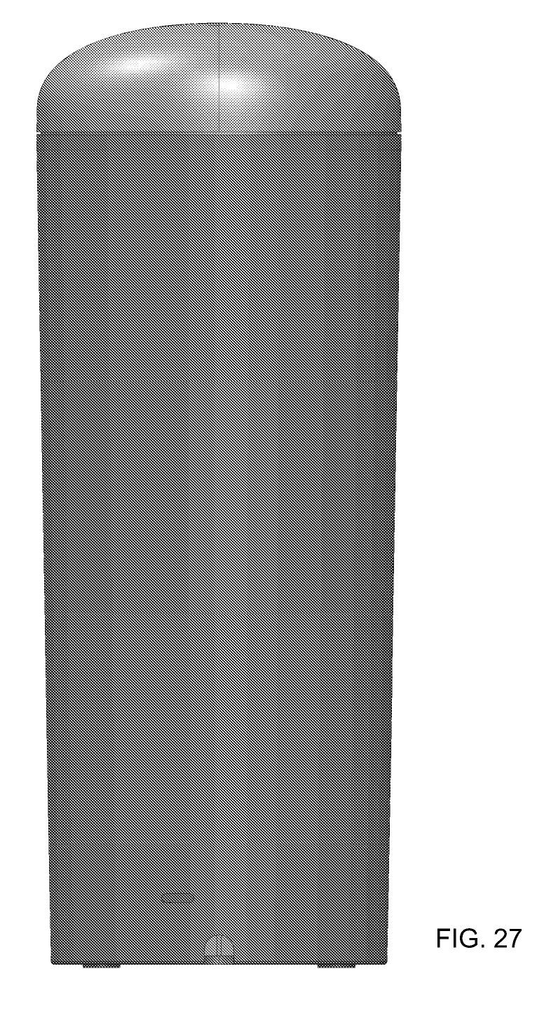

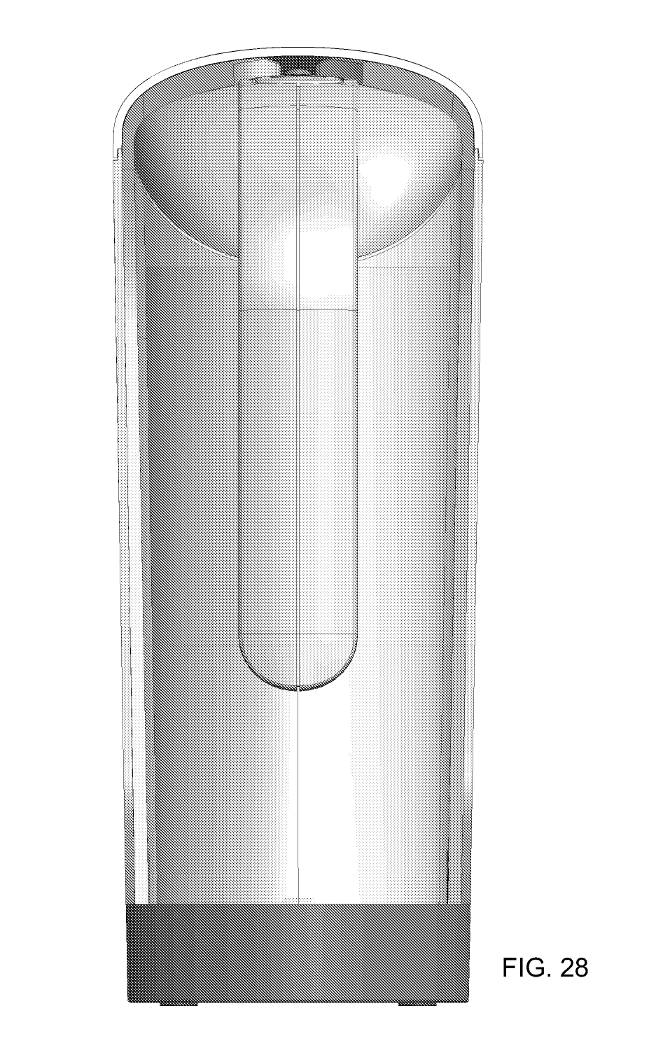

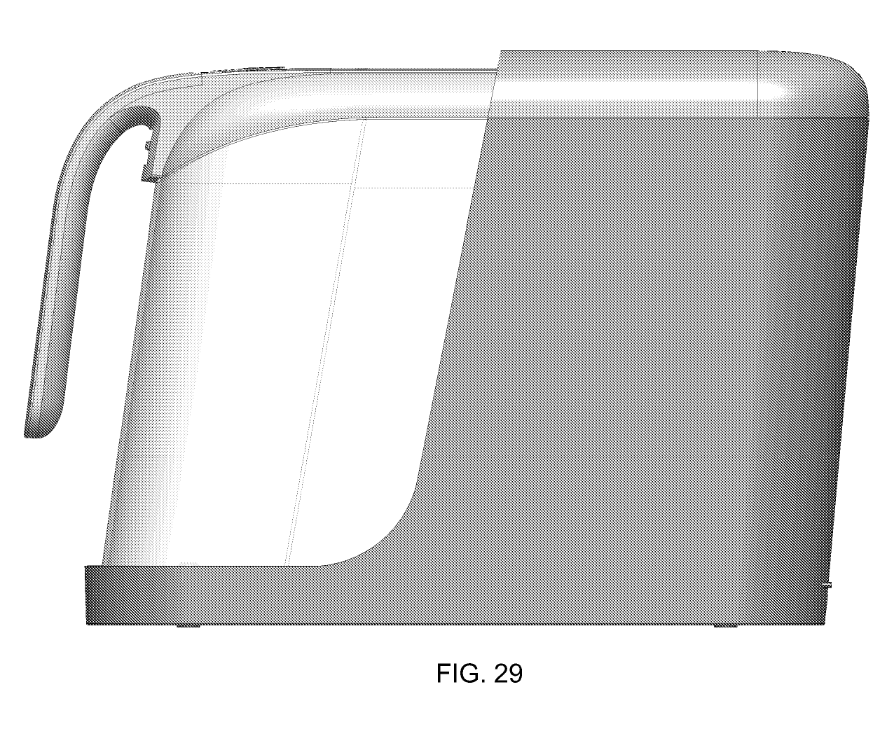

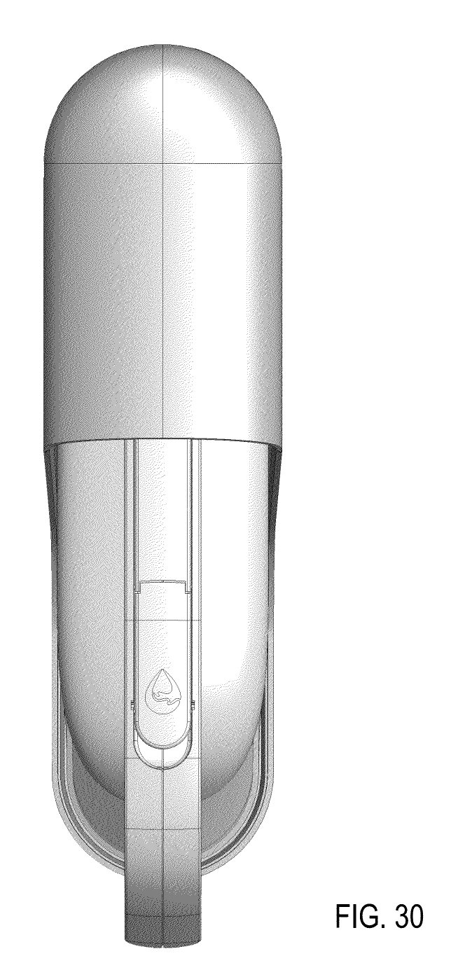

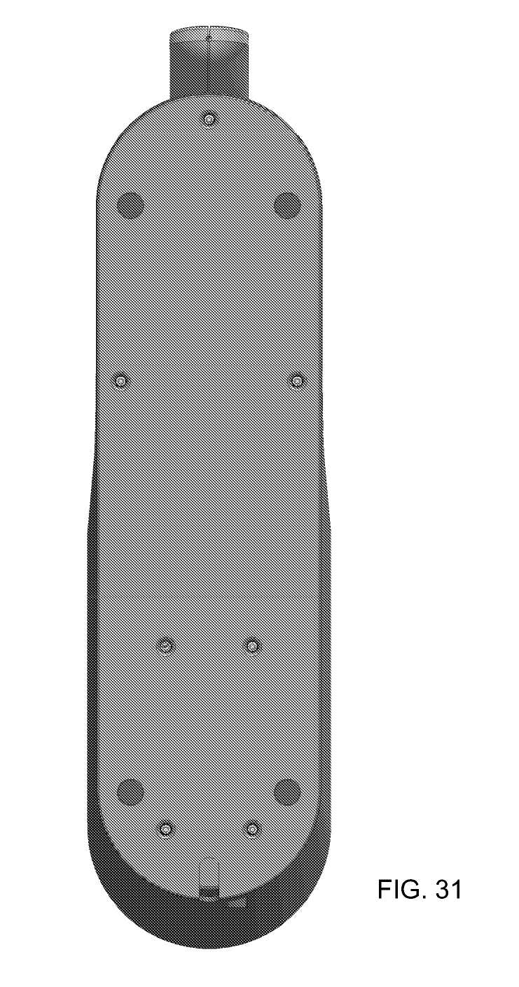

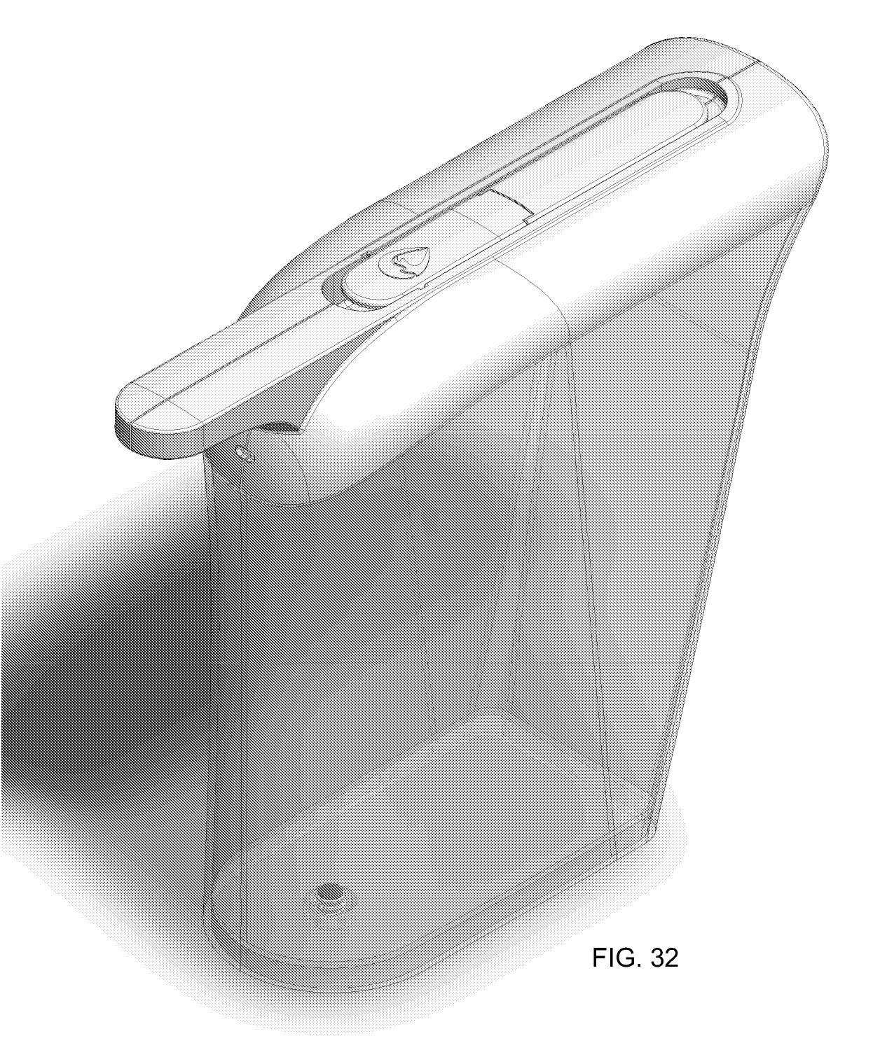

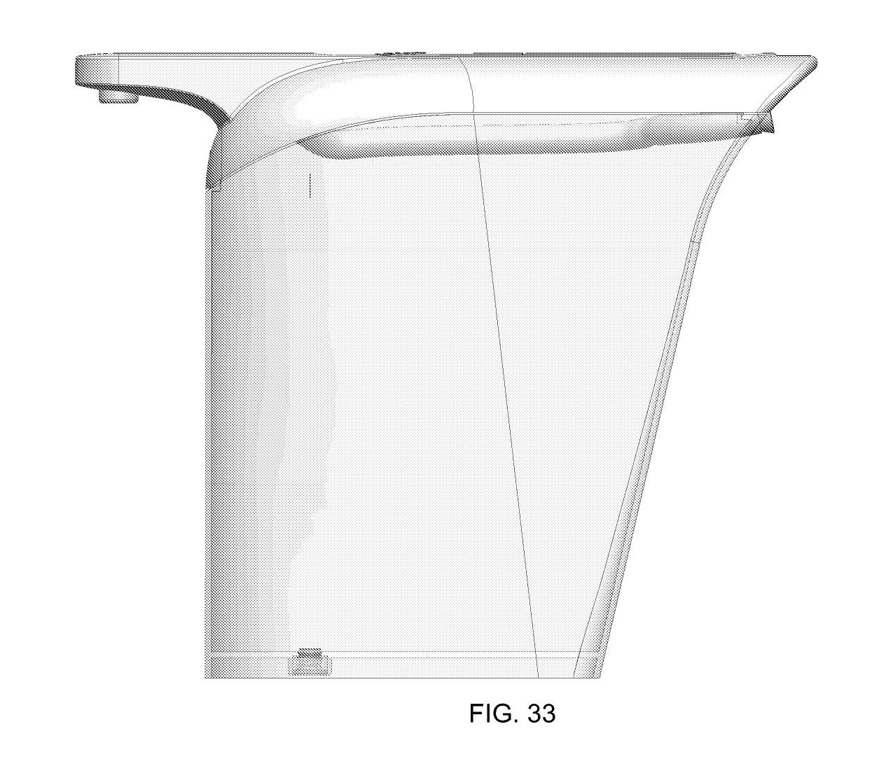

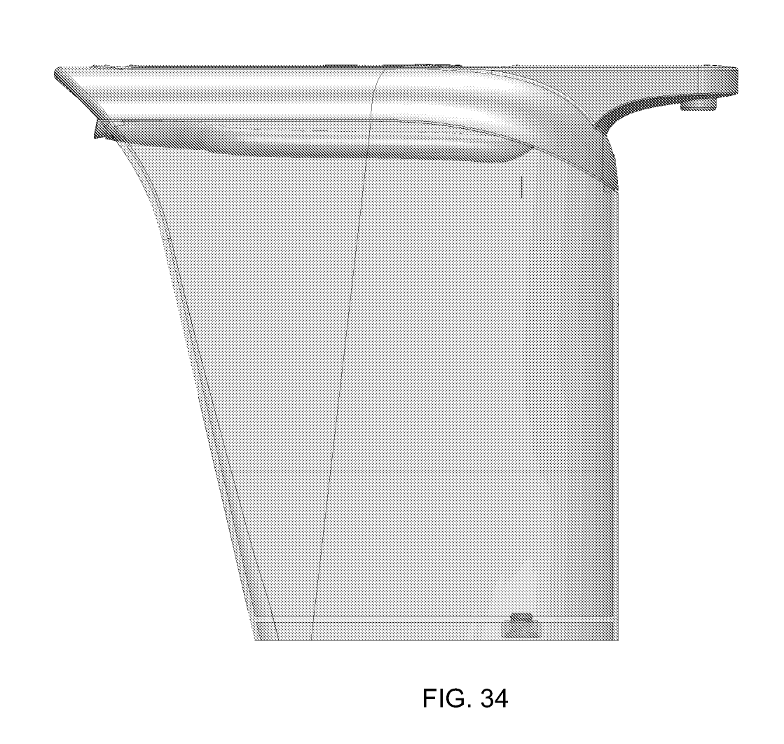

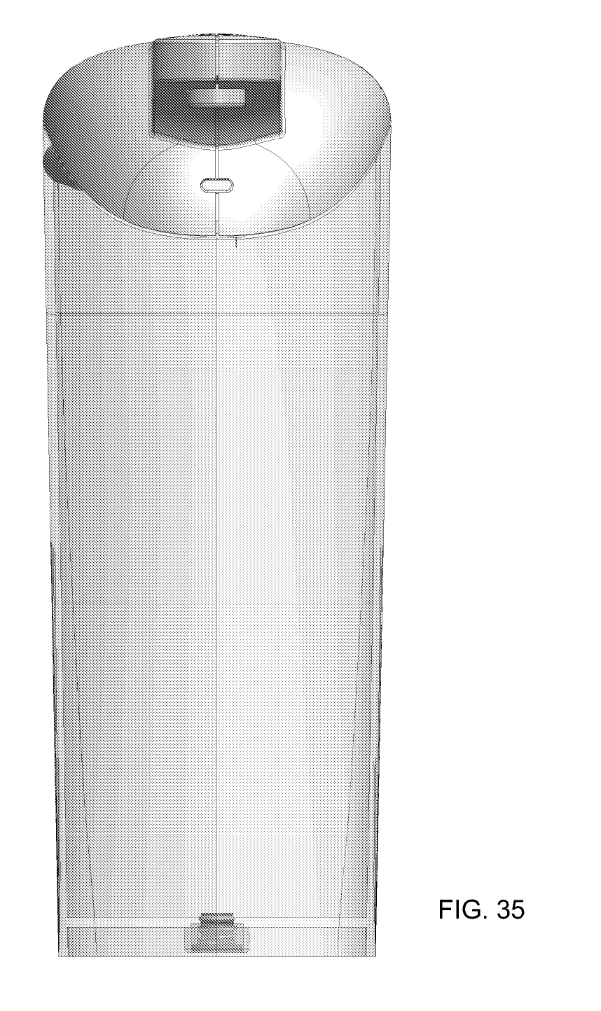

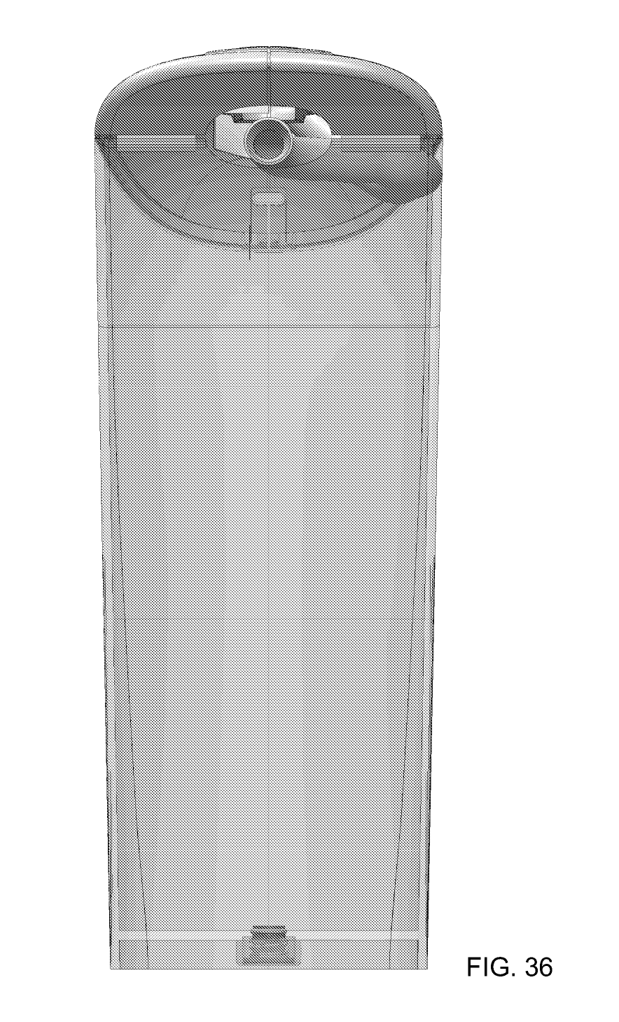

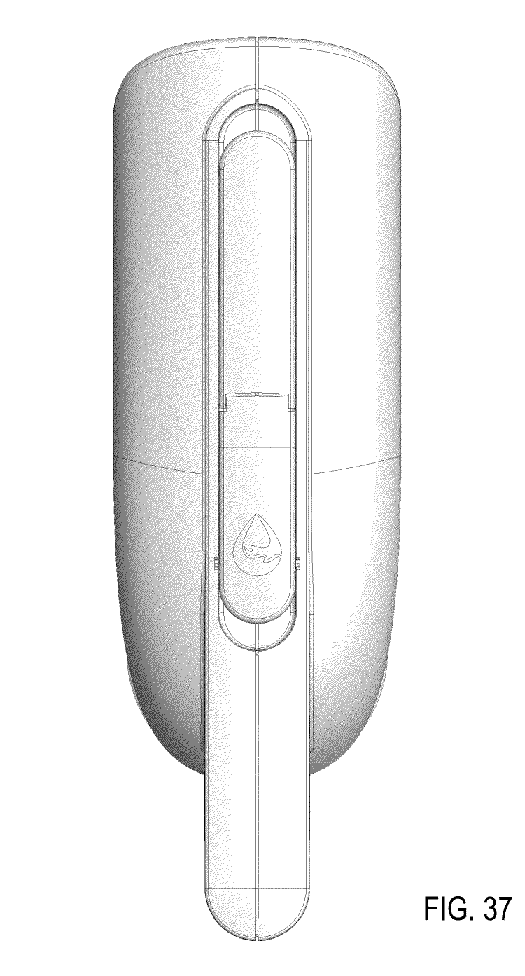

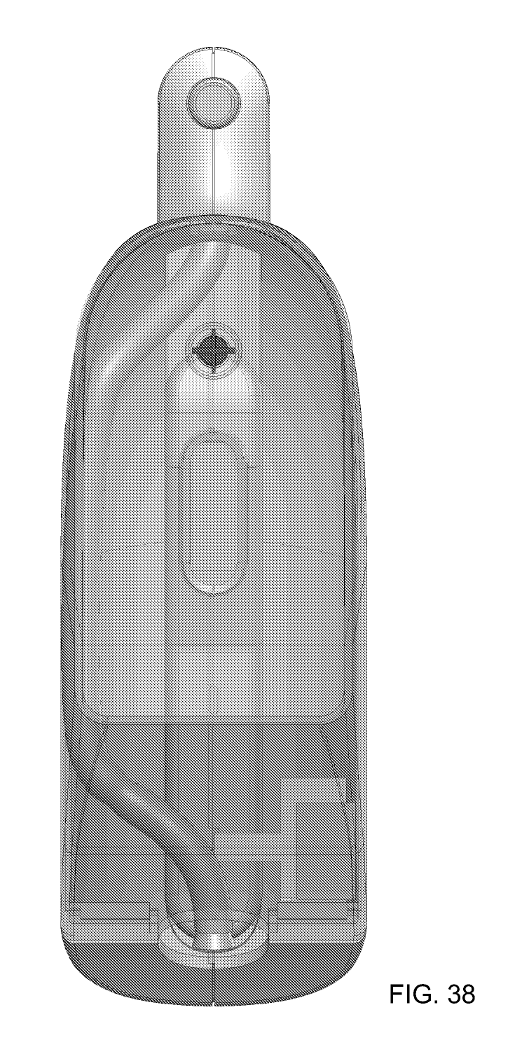

The drawings in this disclosure depict different views of different aspects of the present designs, including perspective, top, bottom, front, rear, and side views (where only one side view of a given embodiment is depicted, the other side view is a mirror image of the depicted side view). The drawings in this disclosure are to scale, meaning the sizes of the depicted elements are accurate relative to each other for at least the embodiments depicted in the drawings.

1. A filtration system comprising:
a pitcher comprising:
a lid; and
a base configured to be coupled to the lid such that the base and the lid cooperate to define a container configured to hold fluid;
a divider separating the container into two compartments that are alongside but not over/under each other; and
a filter base configured to be coupled to the pitcher.
